(19) United States
(12) Patent Application Publication
(10) Pub. No.: US 2025/0239067 A1
(43) Pub. Date: Jul. 24, 2025

(54) AREA DETECTION DEVICE, AREA DETECTION METHOD, AND PROGRAM

(71) Applicant: NIPPON TELEGRAPH AND TELEPHONE CORPORATION, Tokyo (JP)

(72) Inventors: Yujin HAMANO, Tokyo (JP); Kazuaki WATANABE, Tokyo (JP); Daisuke UCHIBORI, Tokyo (JP); Yosuke SAKURADA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/705,365

(22) PCT Filed: Oct. 29, 2021
(86) PCT No.: PCT/JP2021/040165

§ 371 Date: Apr. 26, 2024

(51) Int. Cl. G06V 10/98; G06V 10/24; G06V 10/44

(52) U.S. Cl. CPC G06V 10/98; G06V 10/242; G06V 10/44

(57) ABSTRACT

A region detection device (1) according to the present disclosure includes a line segment detection unit (32) that detects a line segment from a captured image including an image of a target object having a linear band shape, a main line segment extraction unit (33) that extracts a main line segment (SL) that is a line segment having a length equal to or more than a predetermined value; a correction unit (34) that generates, as a corrected image, a rotated image obtained by rotating the captured image such that the main line segment (SL) is perpendicular or parallel to an arrangement direction of pixels in the captured image, and a region detection unit (35) that detects a target object region indicating the image of the target object from the corrected image.

### TECHNICAL FIELD

The present disclosure relates to a region detection device, a region detection method, and a program.

### BACKGROUND ART

There is a technique of detecting a target object region indicating an image of a target object included in a captured image by using an image analysis method such as deep learning. In detecting such a target object region, erroneous detection including non-detection of missing a region indicating an image of a target object or excessive detection of erroneously detecting a region not indicating an image of a target object may occur.

As an example, an example of detecting a region indicating an image of a linear band-shaped target object from a captured image described with reference to FIG. 13A will be described. In this example, target objects are a pipeline PL1 and a pipeline PL2. In the captured image described with reference to FIG. 13A, the respective images of the pipeline PL1 and the pipeline PL2 extend obliquely with respect to a pixel arrangement direction (x-axis direction). The target object regions (regions where images of the pipeline PL1 and the pipeline PL2 are shown) in the captured image described with reference to FIG. 13A are a region R1_true and a region R2_true shown in FIG. 13B, respectively. However, by using the conventional image analysis method, a target object region R90 is detected in FIG. 13C as a region where the images of the pipeline PL1 and the pipeline PL2 are shown, and it is recognized that the target object region R90 in a range of a rectangle N90 indicates one target object. As illustrated in FIG. 13C, the target object region R90 does not include a part of the region where the images of the pipeline PL1 and the pipeline PL2 are shown, and the non-detection occurs.

As another example, an example of detecting a region indicating an image of a linear band-shaped target object from the captured image described with reference to FIG. 14A will be described. Also in this example, target objects are the pipeline PL1 and the pipeline PL2. In a captured image described with reference to FIG. 14A, images of the pipeline PL1 and the pipeline PL2 extend in a direction substantially orthogonal to the pixel arrangement direction (x-axis direction). Regions where the images of the pipeline PL1 and the pipeline PL2 are shown in the captured image described with reference to FIG. 14A are a region R1_true and a region R2_true illustrated in FIG. 14B, respectively. In this example, by using the conventional image analysis method, a target object region R91 and a target object region R92 in FIG. 14C are detected as respective regions where the images of the pipeline PL1 and the pipeline PL2 are shown. It is recognized that each of the target object region R91 and the target object region R92 in the ranges of a rectangle N91 and a rectangle N92 indicates one target object. As illustrated in FIG. 14C, the entire regions where the images of the pipeline PL1 and the pipeline PL2 are shown are included in the target object region R91 and the target object region R92, respectively, and no non-detection has occurred.

As described above, non-detection occurs or does not occur depending on a direction in which an image of a target object extends in a captured image. In order to solve this problem, Non Patent Literature 1 discloses performing tilt correction such that an inspection surface faces an imaging surface in a captured image generated by imaging a target object in a state in which the inspection surface is inclined with respect to the imaging surface. In the tilt correction, it is known that affine transformation is used in which four points in a peripheral region of an image of a target object are set and projection transformation is performed.

### CITATION LIST

### Non Patent Literature

Non Patent Literature 1: Gazo shori sabisu gazo besu infura kozobutsu tennkenn sabisu insupekushon EYE for infura: Canon (in Japanese) (Image Processing Service Image Based Infrastructure Structure Inspection Service Inspection EYE for Infrastructure: Canon) [online], [Searched on Oct. 14, 2021], Internet <URL: https://cweb.canon.jp/imaging-solutions/lineup/inspection-eye/image-processing/>

### SUMMARY OF INVENTION

### Technical Problem

However, in the tilt correction using the affine transformation, it is necessary to manually select four points. Depending on a method of selecting the four points, non-detection occurs in which a part of a region where an image of a pipeline is shown is not included in a detected target object region, and the target object region may not be detected with high accuracy.

An object of the present disclosure made in view of such circumstances is to provide a region detection device, a region detection method, and a program capable of detecting a target object region with high accuracy.

### Solution to Problem

In order to solve the above problem, according to the present disclosure, there is provided a region detection device including a line segment detection unit that detects a line segment from a captured image including an image of a target object having a linear band shape, a main line segment extraction unit that extracts a main line segment that is the line segment having a length equal to or more than a predetermined value; a correction unit that generates, as a corrected image, a rotated image obtained by rotating the captured image such that the main line segment is perpendicular or parallel to an arrangement direction of pixels in the captured image; and a region detection unit that detects a target object region indicating the image of the target object from the corrected image.

In order to solve the above problem, according to the present disclosure, there is provided a region detection method including a step of detecting a line segment from a captured image including an image of a target object having a linear band shape, extracting a main line segment that is the line segment having a length equal to or more than a predetermined value, generating, as a corrected image, a rotated image obtained by rotating the captured image such that the main line segment is perpendicular or parallel to an arrangement direction of pixels in the captured image, and detecting a target object region indicating the image of the target object from the corrected image.

In order to solve the above problem, according to the present disclosure, there is provided a program for causing a computer to function as the above region detection device.

### Advantageous Effects of Invention

According to the region detection device, the region detection method, and the program of the present disclosure, a target object region can be detected with high accuracy.

### BRIEF DESCRIPTION OF DRAWINGS

FIG. 1 is a schematic diagram of a region detection system according to a first embodiment.

FIG. 2A is a diagram illustrating an example of a captured image acquired by an image acquisition device illustrated in FIG. 1.

FIG. 2B is a diagram illustrating line segments extracted from the captured image illustrated in FIG. 2A.

FIG. 2C is a diagram in which a main line segment detected from the line segments illustrated in FIG. 2B is emphasized in the captured image illustrated in FIG. 2A.

FIG. 3A is a diagram illustrating an angle of a direction in which the main line segment extends with respect to an arrangement direction of pixels in the captured image illustrated in FIG. 2C.

FIG. 3B is a diagram illustrating a rotated image obtained by rotating the captured image illustrated in FIG. 3A.

FIG. 3C is a diagram illustrating an example of a corrected image obtained by reducing the captured image illustrated in FIG. 3B.

FIG. 3D is a diagram illustrating another example of the corrected image obtained by reducing the captured image illustrated in FIG. 3B.

FIG. 4 is a diagram illustrating an image having the same size as the captured image and including a part of the rotated image illustrated in FIG. 3B.

FIG. 5 is a diagram illustrating target object region information generated from the corrected image illustrated in FIG. 3C.

FIG. 6 is a flowchart illustrating an example of an operation in the region detection device illustrated in FIG. 1.

FIG. 7 is a schematic diagram of a region detection system according to a second embodiment.

FIG. 8 is a flowchart illustrating an example of an operation in the region detection device illustrated in FIG. 7.

FIG. 9 is a schematic diagram of a region detection system according to a third embodiment.

FIG. 10 is a flowchart illustrating an example of an operation in the region detection device illustrated in FIG. 9.

FIG. 11 is a diagram obtained by reversely rotating the target object region information illustrated in FIG. 5.

FIG. 12 is a hardware block diagram of the region detection device.

FIG. 13A is a diagram illustrating an example of a captured image.

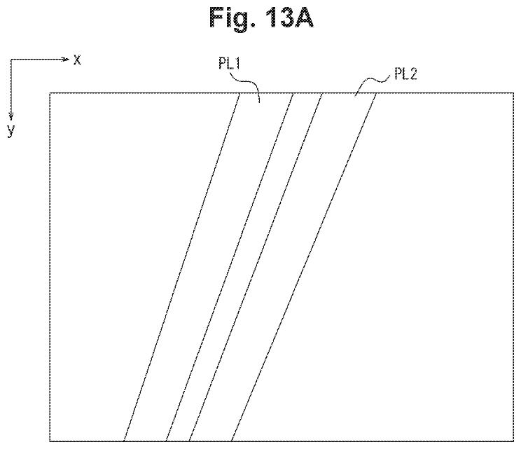

FIG. 13B is a diagram illustrating a target object region in the captured image illustrated in FIG. 13A.

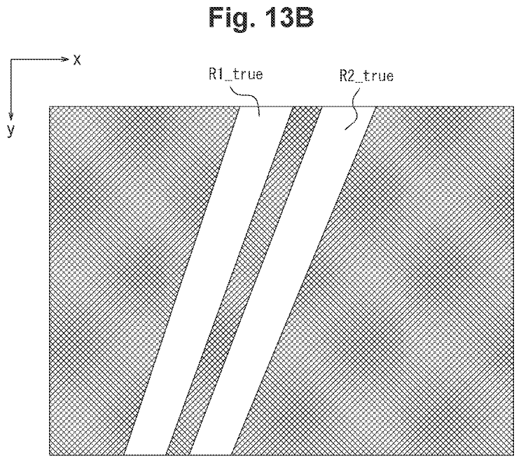

FIG. 13C is a diagram illustrating a target object region detected from the captured image illustrated in FIG. 13A.

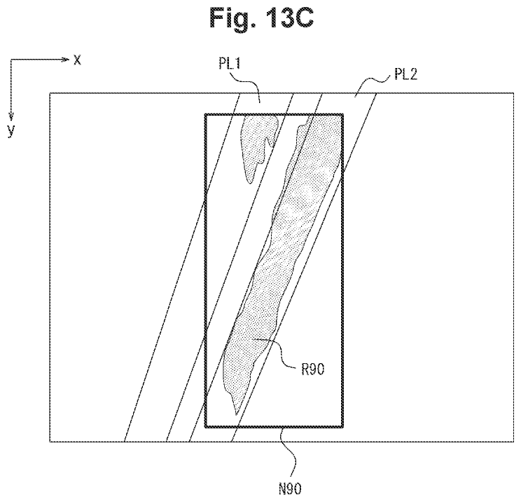

FIG. 14A is a diagram illustrating another example of the captured image.

FIG. 14B is a diagram illustrating a target object region in the captured image illustrated in FIG. 14A.

FIG. 14C is a diagram illustrating a target object region detected from the captured image illustrated in FIG. 14A.

### DESCRIPTION OF EMBODIMENTS

### First Embodiment

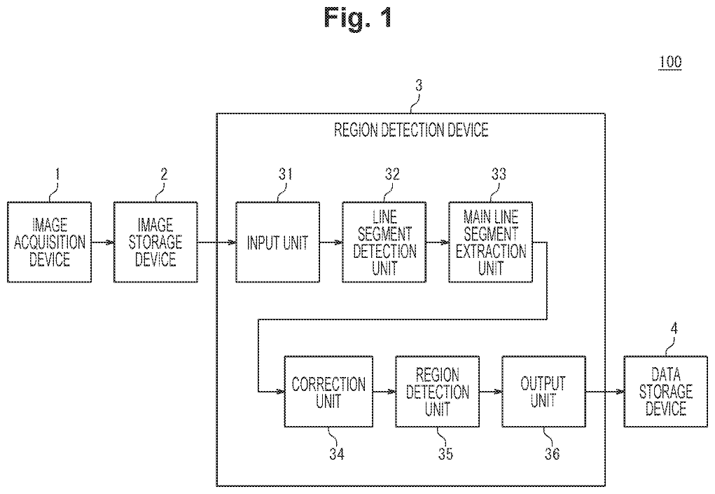

An overall configuration of a first embodiment will be described with reference to FIG. 1.

As illustrated in FIG. 1, a region detection system 100 according to the first embodiment includes an image acquisition device 1, an image storage device 2, a region detection device 3, and a data storage device 4.

### <Configuration of Image Acquisition Device>

The image acquisition device 1 may be configured with a camera including an optical element, an imaging element, and an output interface. The output interface is an interface for outputting information.

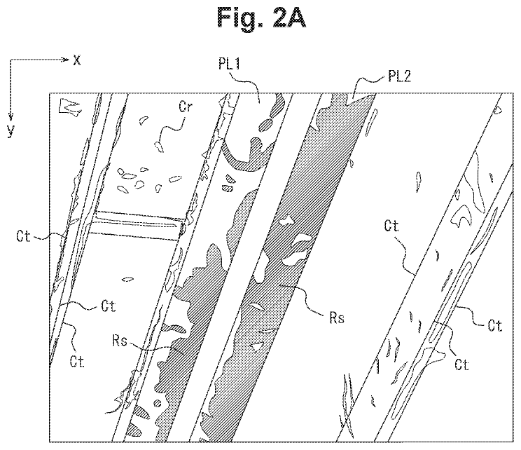

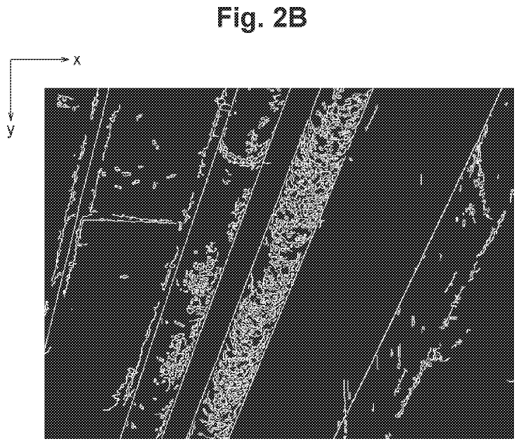

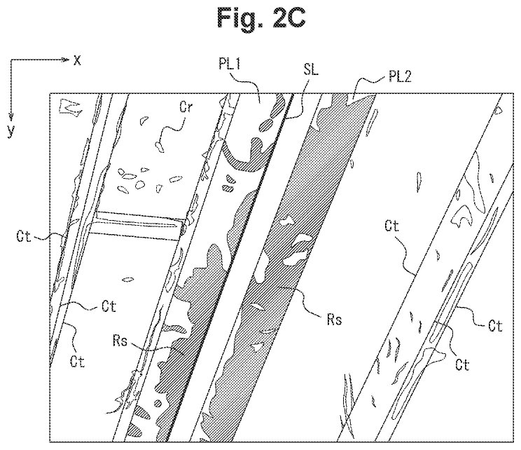

The image acquisition device 1 acquires a captured image obtained by capturing a target object having a linear band shape. As illustrated in FIG. 2A, the captured image includes pixels two-dimensionally arranged in each of a predetermined direction (x-axis direction) and a direction (y-axis direction) orthogonal to the predetermined direction. The captured image is desirably an RGB image.

The target object may be a member that is an inspection target. The target object having the linear band shape may be a member that forms a structure and extends in one direction. In the example illustrated in FIG. 2A, target objects having a linear band shape in the captured image are a pipeline PL1 and a pipeline PL2. In the following description, the pipeline PL1 and the pipeline PL2 may be simply referred to as a “pipeline PL”.

In the example illustrated in FIG. 2A, in the captured image, the image of the pipeline PL extends obliquely with respect to the pixel arrangement direction (x-axis direction). In the present example, the captured image includes images of structures such as a wall, a beam, and a ceiling of a building in which the pipeline PL is disposed, in addition to the pipeline PL, and FIG. 2A illustrates contours Ct of the images of the structures. In the present example, the captured image also includes images of a damaged portion Cr of the structure and a damaged portion Rs including rust, dirt, defect, and the like of the pipeline PL. In FIG. 2A, the reference signs Ct, Cr, and Rs are attached only to the contour of the structure, the damaged portion of the structure, and a part of the damaged portion of the pipeline PL, respectively.

The image acquisition device 1 also outputs the captured image to an image storage device 2.

### <Configuration of Image Storage Device>

The image storage device 2 illustrated in FIG. 1 may be a personal computer (PC), a tablet terminal, or the like. The image storage device 2 may be configured by a computer including a memory, a controller, an input interface, and an output interface. The memory may include a hard disk drive (HDD), a solid state drive (SSD), an electrically erasable programmable read-only memory (EEPROM), a read-only memory (ROM), a random access memory (RAM), and the like. The controller may be configured by dedicated hardware such as an application specific integrated circuit (ASIC) or a field-programmable gate array (FPGA), may be configured by a processor, or may be configured to include both. The input interface may be a pointing device, a keyboard, a mouse, or the like. The input interface may be an interface that receives input of information received by a communications interface. For the communication interface, a standard such as Ethernet (registered trademark), Fiber Distributed Data Interface (FDDI), or Wi-Fi (registered trademark) may be used, for example.

The image storage device 2 receives input of the captured image acquired by the image acquisition device 1, and stores the captured image. The image storage device 2 outputs the captured image to a region detection device 3.

### <Configuration of Region Detection Device>

The region detection device 3 includes an input unit 31, a line segment detection unit 32, a main line segment extraction unit 33, a correction unit 34, a region detection unit 35, and an output unit 36. The input unit 31 is configured by an input interface. The line segment detection unit 32, the main line segment extraction unit 33, the correction unit 34, and the region detection unit 35 are configured by a controller. The output unit 36 is configured by an output interface.

The input unit 31 receives input of image data indicating the captured image as exemplified in FIG. 2A stored in the image storage device 2. The input unit 31 may receive input of image data from the image acquisition device 1 without passing through the image storage device 2.

The input unit 31 may be configured by an input interface and may be further configured by a controller. In such a configuration, the input unit 31 may add an identifier for uniquely identifying the image data to the image data of which the input has been received. The identifier may be, for example, a number. The identifier may be a number obtained by adding a predetermined value in the order in which the image data is input. The predetermined value may be 1. As a result, even in a case where input of a plurality of pieces of image data is received, a result of processing performed by each functional unit that will be described later may be associated with the image data.

The line segment detection unit 32 executes preprocessing for the region detection unit 35 that will be described in detail later to execute processing on the captured image indicated by the image data of which input has been received by the input unit 31. Specifically, the line segment detection unit 32 detects a line segment from a captured image including an image of a target object having a linear band shape. The line segment detection unit 32 may detect a line segment from the captured image by using a general image processing method such as Hough transform, probabilistic Hough transform, or a line segment detector (LSD). For example, the line segment detection unit 32 detects a line segment as illustrated in white in FIG. 2B from the captured image illustrated in the example in FIG. 2A by using Hough transform.

The main line segment extraction unit 33 extracts a main line segment SL that is a line segment having a length equal to or more than a predetermined value as illustrated in FIG. 2C from the line segments detected by the line segment detection unit 32. The predetermined value is a value greater than the detection threshold value described above, and may be set as appropriate according to a size of a target object, settings of the image acquisition device 1, a distance between the image acquisition device 1 and the target object, and the like. The main line segment extraction unit 33 may extract the main line segment SL that is a line segment having the maximum length from the line segments detected by the line segment detection unit 32.

Due to images of various subjects (for example, structures (beam, column, ceiling, and the like) other than the target object, the damaged portion Cr of the structure, the damaged portion Rs of the target object, and the like) included in the captured image, a plurality of line segments having various lengths are detected by the line segment detection unit 32. In contrast, since the image of the pipeline PL, which is a target object having a linear band shape, extends with a constant length, the main line segment SL, which is a line segment having a length equal to or more than a predetermined value, is expected to be a line segment extending in the extending direction of the image of the pipeline PL. That is, the main line segment extraction unit 33 can extract a line segment extending in the extending direction of the target object as the main line segment SL.

Note that the line segment detection unit 32 described above may detect a line segment having a length equal to or more than a preset detection threshold value, or may detect all line segments. In the configuration in which all the line segments are detected, the line segment detection unit 32 can detect a large number of line segments compared with the case of detecting a line segment having a length equal to or more than a preset detection threshold value. As a result, the main line segment extraction unit 33 extracts the main line segment SL from more line segments, so that the main line segment SL can be extracted with higher accuracy.

The correction unit 34 generates, as a corrected image, a rotated image obtained by rotating the captured image such that the main line segment SL is perpendicular or parallel to the arrangement direction of the pixels in the captured image.

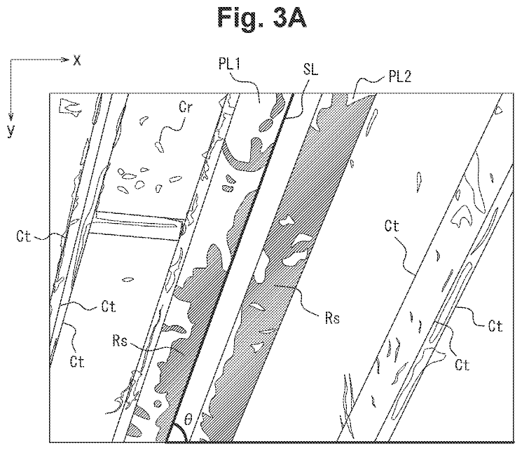

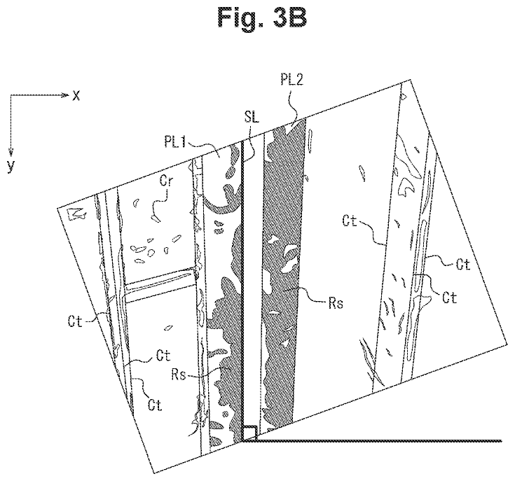

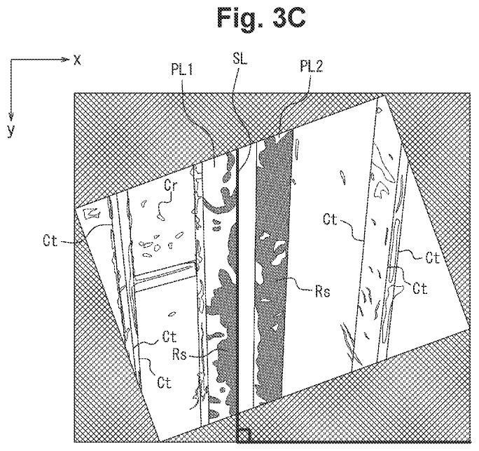

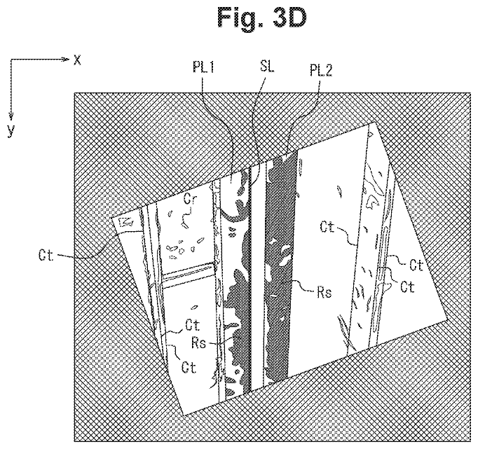

Specifically, first, the correction unit 34 calculates an angle θ (refer to FIG. 3A) formed by the extending direction of the main line segment SL extracted by the main line segment extraction unit 33 with respect to the arrangement direction (x-axis direction) of the pixels in the captured image.

As illustrated in FIG. 3B, the correction unit 34 generates a rotated image obtained by rotating the captured image such that the angle θ becomes 0° or 90°. For example, the correction unit 34 may rotate the captured image (90°−θ) with the center of the captured image as the center point of rotation such that the angle θ becomes 90°. The correction unit 34 may generate an image obtained by rotating the captured image around any point of the captured image, and may generate a rotated image by moving the image in parallel such that the center of the image becomes the center of the captured image.

The correction unit 34 may generate a rotated image obtained by rotating the captured image by using, for example, an image processing library such as Opencv or pillow or image processing software. In this case, the correction unit 34 desirably uses affine transformation to rotate the captured image on the basis of any angle θ.

The correction unit 34 may generate, as a corrected image, an image obtained by reducing the rotated image such that the entire region of the captured image includes the entire rotated image. Specifically, the correction unit 34 may generate a corrected image obtained by reducing the rotated image such that the entire region of the captured image includes the entire rotated image. As illustrated in FIG. 3C, the correction unit 34 may generate a corrected image obtained by reducing the rotated image to maximize an area while the entire rotated image is included in the entire region of the captured image. As illustrated in FIG. 3D, the correction unit 34 may generate a corrected image obtained by further reducing the rotated image compared with the case illustrated in FIG. 3C.

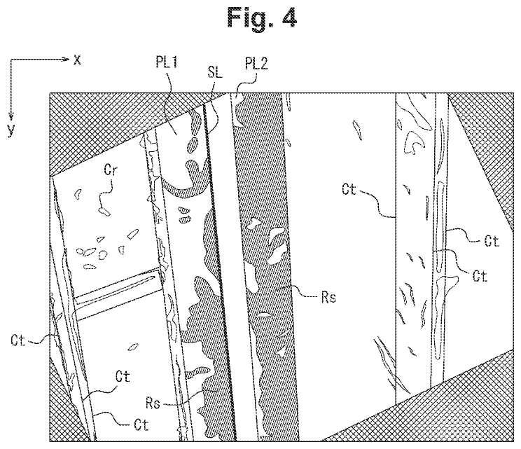

If the image obtained by rotating the captured image is not reduced, a portion (missing portion) not included in the entire region of the captured image occurs in the corrected image. In the example illustrated in FIG. 4, a part of the upper end portion of the image of the pipeline PL2 illustrated in FIGS. 3A and 3B is not illustrated, and the part is a missing portion. In the example illustrated in FIG. 4, a part of the lower end portion of each of the images of the pipelines PL1 and PL2 illustrated in FIGS. 3A and 3B is not illustrated, and the part is a missing portion. In contrast, as illustrated in FIGS. 3B and 3C, the correction unit 34 generates a corrected image obtained by reducing the rotated image, so that it is possible to suppress the occurrence of a missing portion.

As described above, the correction unit 34 generates the corrected image, so that the image of the pipeline PL extends in a direction horizontal or vertical to the pixel arrangement direction in the corrected image. Therefore, an aspect ratio of the rectangle formed by the line segments along the arrangement direction of the pixels surrounding the image of the pipeline PL increases.

The region detection unit 35 detects a target object region indicating the image of the target object from the corrected image. The region detection unit 35 may detect a target object region by using any method. For example, the region detection unit 35 may detect a target object region according to a method using deep learning. Specifically, the region detection unit 35 may detect an image of an inspection target object by using a bounding box (for example, You Only Look Once (YOLO)). For example, the region detection unit 35 detects an image of an inspection target object by using segmentation for each class through instance segmentation (for example, Mask-R-CNN) or the like.

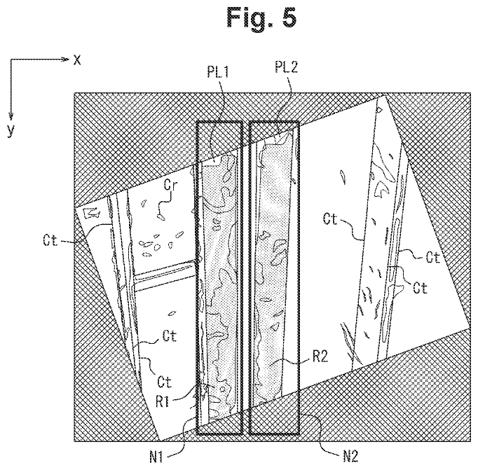

The output unit 36 outputs target object region information indicating the target object region detected by the region detection unit 35. The target object region information may be, for example, information indicating an image in which a predetermined color or pattern is added to the target object region in the corrected image. The target object region information may be information indicating an image in which a rectangle surrounding the target object region is superimposed on the corrected image. In the example illustrated in FIG. 5, the target object region information is information indicating an image in which a predetermined pattern (halftone pattern) is added to the target object regions R1 and R2 in the corrected image and rectangles N1 and N2 surrounding the target object regions R1 and R2, respectively, are superimposed. In FIG. 5, hatching indicating an image of the damaged portion Rs of the pipeline PL illustrated in FIGS. 2A, 2C, and 3A to 3D is omitted.

The output unit 36 may output the target object region information to the data storage device 4 via a communication network. The output unit 36 may output the target object region information to a display device including an organic electro luminescence (EL), a liquid crystal panel, or the like.

### <Configuration of the Data Storage Device>

The data storage device 4 illustrated in FIG. 1 is configured by a computer including a memory, a controller, and an input interface. The data storage device 4 stores the target object region information output from the region detection device 3.

### <Operation of Region Detection Device>

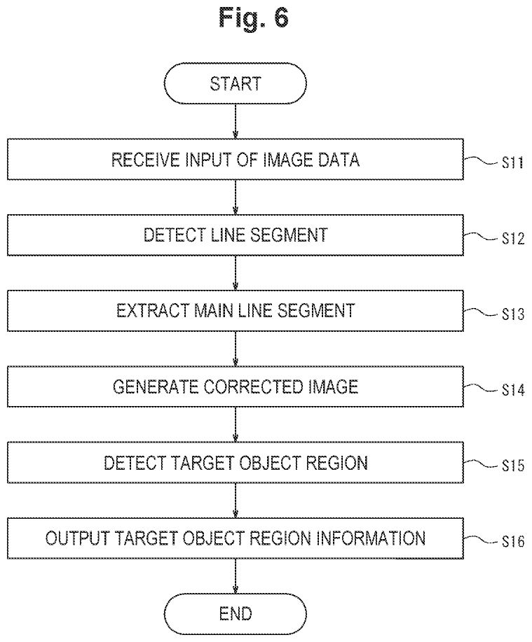

Here, an operation of the region detection device 3 according to the first embodiment will be described with reference to FIG. 6. FIG. 6 is a flowchart illustrating an example of the operation of the region detection device 3 according to the first embodiment. The operation of the region detection device 3 described with reference to FIG. 6 corresponds to an example of a region detection method of the region detection device 3 according to the first embodiment.

In step S11, the input unit 31 receives input of image data indicating the captured image stored in the image storage device 2. The input unit 31 may receive input of image data from the image acquisition device 1 without passing through the image storage device 2.

In step S12, the line segment detection unit 32 detects a line segment from a captured image including the image of the target object having a linear band shape. In the present embodiment, the captured image is a captured image indicated by the image data input in step S11.

In step S13, the main line segment extraction unit 33 extracts the main line segment SL that is a line segment having a length equal to or more than a predetermined value.

In step S14, the correction unit 34 generates, as a corrected image, a rotated image obtained by rotating the captured image such that the main line segment SL is perpendicular or parallel to the arrangement direction of the pixels in the captured image. Here, the correction unit 34 may generate, as the corrected image, an image obtained by reducing the rotated image such that the entire region of the captured image includes the entire rotated image.

In step S15, the region detection unit 35 detects a target object region indicating the image of the target object from the corrected image.

In step S16, the output unit 36 outputs target object region information indicating the target object region.

Note that the region detection device 3 does not need to execute step S1. In such a configuration, the line segment detection unit 32 may detect a line segment from a captured image stored in advance by the region detection device 3 or generated by the region detection device 3. The region detection device 3 does not need to execute step S16. In such a configuration, the region detection device 3 may include a storage unit configured by a memory, and the storage unit may store the target object region information.

As described above, according to the first embodiment, the region detection device 3 includes the line segment detection unit 32 that detects a line segment from a captured image including an image of a target object having a linear band shape, the main line segment extraction unit 33 that extracts the main line segment SL that is a line segment having a length equal to or more than a predetermined value, the correction unit 34 that generates, as a corrected image, a rotated image obtained by rotating the captured image such that the main line segment SL is perpendicular or parallel to an arrangement direction of pixels in the captured image, and the region detection unit 35 that detects a target object region indicating an image of the target object from the corrected image.

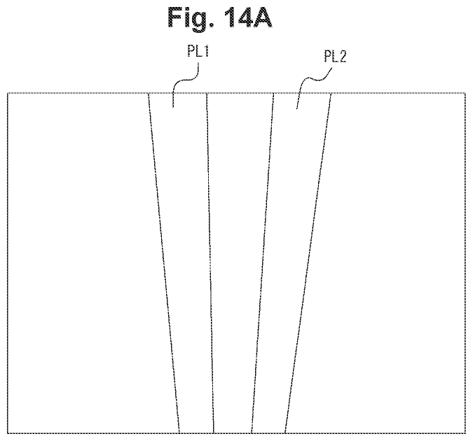

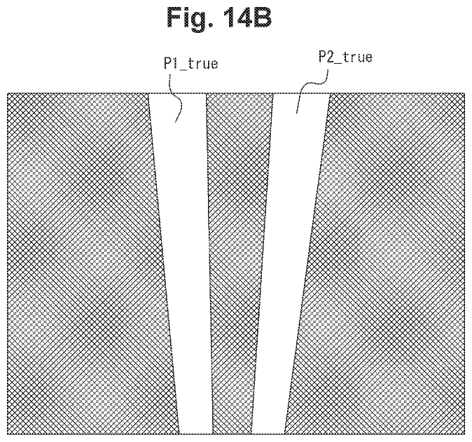

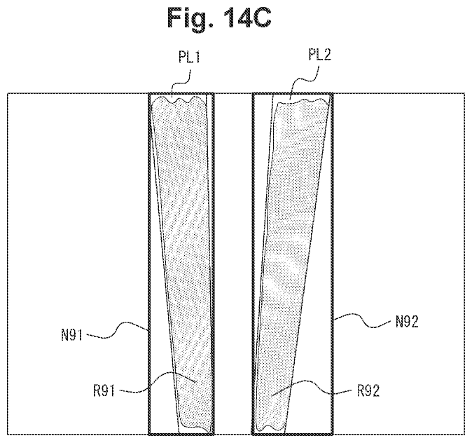

As described with reference to FIGS. 14A to 14C, in a case where the image of the target object such as the pipeline PL extends obliquely with respect to the arrangement direction of the pixels, it is known that the target object region cannot be detected with high accuracy due to a small aspect ratio of the rectangle surrounding the image of the target object and formed by line segments along the arrangement direction of the pixels. In contrast, the region detection device 3 of the present embodiment generates the corrected image in which the captured image is rotated and reduced such that the main line segment SL is perpendicular or parallel to the arrangement direction of the pixels with the above-described configuration, and thus the image of the target object extends in the arrangement direction of the pixels in the corrected image. Therefore, since an aspect ratio of the rectangle surrounding the image of the target object and formed by the line segments along the arrangement direction of the pixels increases, the region detection device 3 can detect the target object region with high accuracy. Accordingly, the region detection device 3 can inspect the target object with higher accuracy by further extracting the region where the target object is damaged in the target object region, and can thus appropriately maintain the safety of buildings, facilities, and the like formed by using the target object.

### Second Embodiment

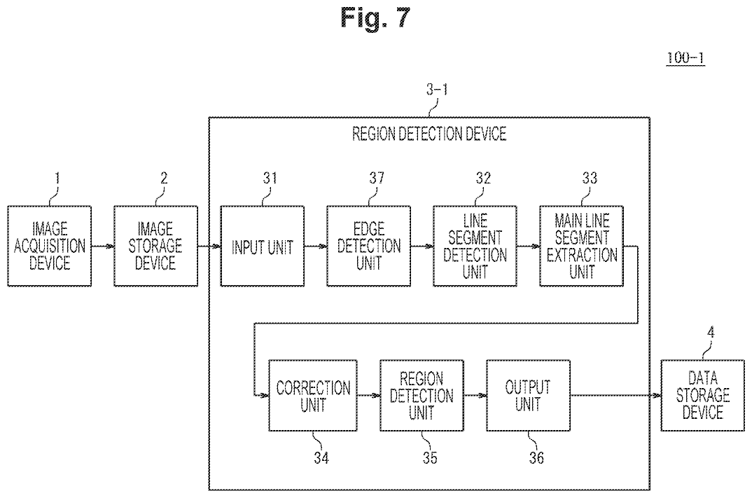

An overall configuration of a second embodiment will be described with reference to FIG. 7. In the second embodiment, the same functional units as those in the first embodiment are denoted by the same reference numerals, and description thereof will not be repeated.

As illustrated in FIG. 7, a region detection system 100-1 according to the second embodiment includes an image acquisition device 1, an image storage device 2, a region detection device 3-1, and a data storage device 4.

### <Configuration of Region Detection Device>

The region detection device 3-1 includes an input unit 31, a line segment detection unit 32, a main line segment extraction unit 33, a correction unit 34, a region detection unit 35, an output unit 36, and an edge detection unit 37. The edge detection unit 37 is configured by a controller.

The edge detection unit 37 detects an edge from a captured image. Specifically, the edge detection unit 37 detects an edge on the basis of luminance discontinuity in the captured image. For example, the edge detection unit 37 may calculate a difference in luminance between a pixel in the captured image and a pixel adjacent to the pixel, and detect a pixel having an absolute value of the difference more than a predetermined edge threshold value as an edge.

The line segment detection unit 32 detects a line segment from the edge detected by the edge detection unit 37.

### <Operation of Region Detection Device>

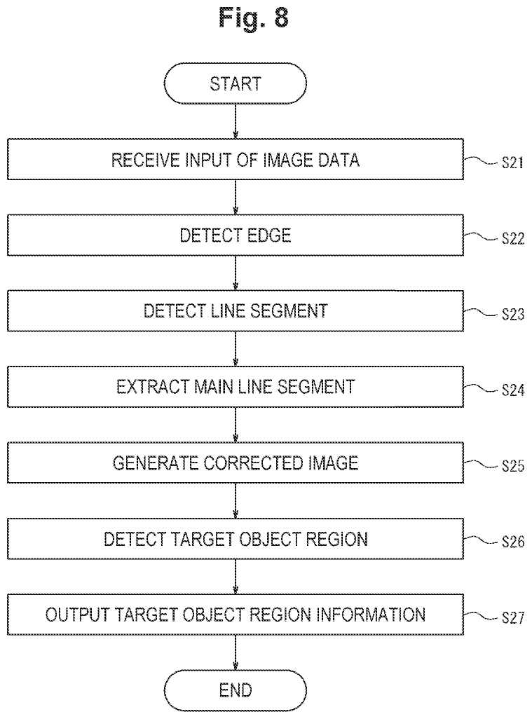

Here, an operation of the region detection device 3-1 according to the second embodiment will be described with reference to FIG. 8. FIG. 8 is a flowchart illustrating an example of the operation of the region detection device 3-1 according to the second embodiment. The operation of the region detection device 3-1 described with reference to FIG. 8 corresponds to an example of a region detection method of the region detection device 3-1 according to the second embodiment.

The region detection device 3-1 executes the process in step S21. The process in step S21 is the same as the process in step S11 in the first embodiment.

In step S22, the edge detection unit 37 detects an edge from the captured image.

In step S23, the line segment detection unit 32 detects a line segment from the edge detected in step S22.

Subsequently, the region detection device 3-1 executes processing from step S24 to step S27. The processes from step S24 to step S27 are the same as the processes from step S13 to step S16 in the first embodiment.

As described above, according to the second embodiment, the region detection device 3-1 further includes the edge detection unit 37 that detects an edge from the captured image, and the line segment detection unit 32 detects a line segment from the edge. As a result, the region detection device 3-1 can generate a corrected image such that the image of the target object extends in the arrangement direction of the pixels more appropriately by detecting the boundary of the image of the target object. Therefore, the region detection device 3-1 can detect the target object region with higher accuracy than in the configuration in which the line segment is directly detected from the captured image.

### Third Embodiment

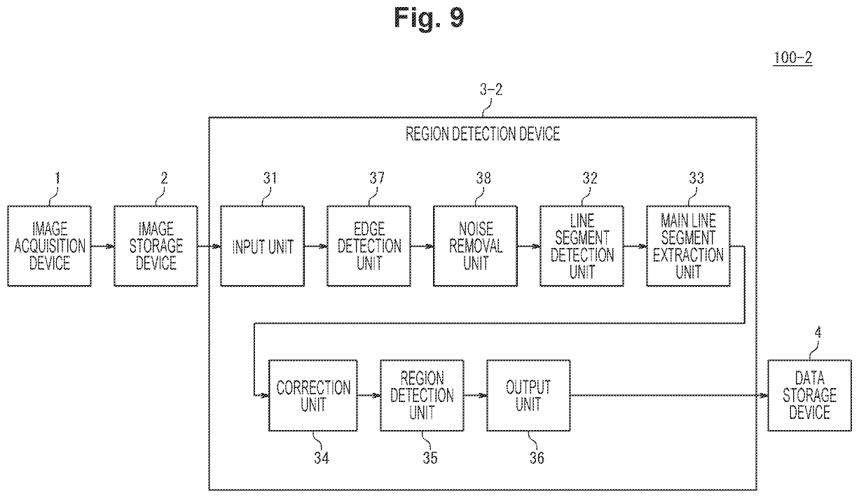

An overall configuration of a third embodiment will be described with reference to FIG. 9. In the third embodiment, the same functional units as those in the second embodiment are denoted by the same reference numerals, and description thereof will not be repeated.

As illustrated in FIG. 9, a region detection system 100-2 according to the third embodiment includes an image acquisition device 1, an image storage device 2, a region detection device 3-2, and a data storage device 4.

### <Configuration of Region Detection Device>

The region detection device 3-2 includes an input unit 31, a line segment detection unit 32, a main line segment extraction unit 33, a correction unit 34, a region detection unit 35, an output unit 36, an edge detection unit 37, and a noise removal unit 38. The noise removal unit 38 is configured by a controller.

The noise removal unit 38 removes noise that is an edge less than a predetermined edge threshold value among edges detected by the edge detection unit 37.

The line segment detection unit 32 detects a line segment from an edge detected by the edge detection unit 37 and not removed by the noise removal unit 38.

### <Operation of Region Detection Device>

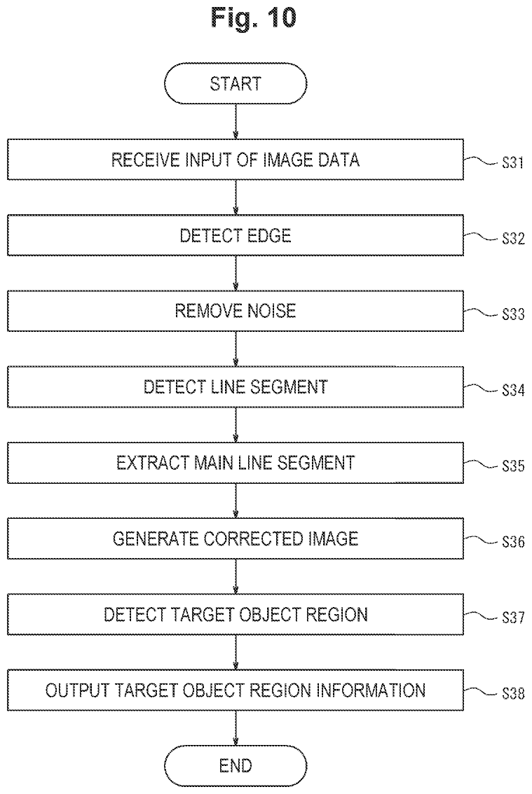

Here, an operation of the region detection device 3-2 according to the third embodiment will be described with reference to FIG. 10. FIG. 10 is a flowchart illustrating an example of an operation of the region detection device 3-2 according to the third embodiment. The operation of the region detection device 3-2 described with reference to FIG. 10 corresponds to an example of a region detection method of the region detection device 3-2 according to the third embodiment.

The region detection device 3-2 executes the processes in step S31 and step S32. The processes in steps S31 and S32 are the same as the processes in steps S21 and S22 in the second embodiment.

In step S33, the noise removal unit 38 removes noise that is an edge less than a predetermined edge threshold value among the edges detected by the edge detection unit 37.

In step S34, the line segment detection unit 32 detects a line segment from an edge detected by the edge detection unit 37 and not removed by the noise removal unit 38.

Subsequently, the region detection device 3-2 executes the processes from step S35 to step S38. The processes from steps S35 to S38 are the same as the processes from steps S24 to S27, respectively, in the second embodiment.

As described above, according to the third embodiment, the region detection device 3-2 further includes the noise removal unit 38 that removes noise that is an edge less than a predetermined edge threshold value among the edges, and the line segment detection unit 32 detects a line segment from an edge detected by the edge detection unit 37 and not removed by the noise removal unit 38. As a result, the region detection device 3-2 can suppress erroneous detection of a line segment, and thus can detect a target object region with high accuracy.

### MODIFICATION EXAMPLES

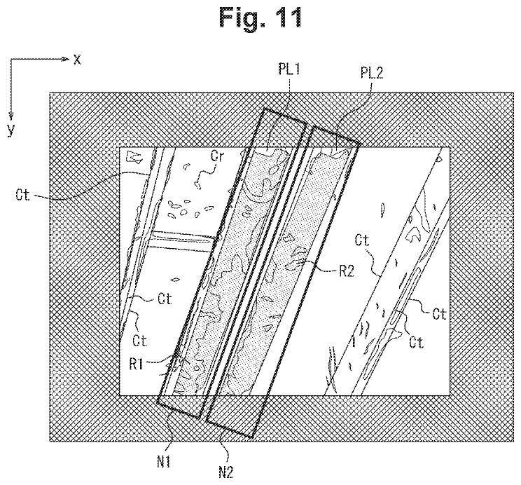

In the first embodiment described above, the region detection device 3 may further include a reverse rotation correction unit. The reverse rotation correction unit rotates the image indicated by the target object region information as illustrated in FIG. 5 by an angle (θ−90°) to generate a reversely rotated image as illustrated in FIG. 11. In other words, the reverse rotation correction unit rotates the image indicated by the target object region information by the same angle in a direction reverse to the direction in which the correction unit 34 has rotated the captured image to generate the reversely rotated image. In such a configuration, the output unit 36 may output information indicating the reversely rotated image as target object region information to the data storage device 4, the display device, and the like. The region detection device 3-1 of the second embodiment may further include a reverse rotation correction unit, and the region detection device 3-2 of the third embodiment may further include a reverse rotation correction unit.

### <Program>

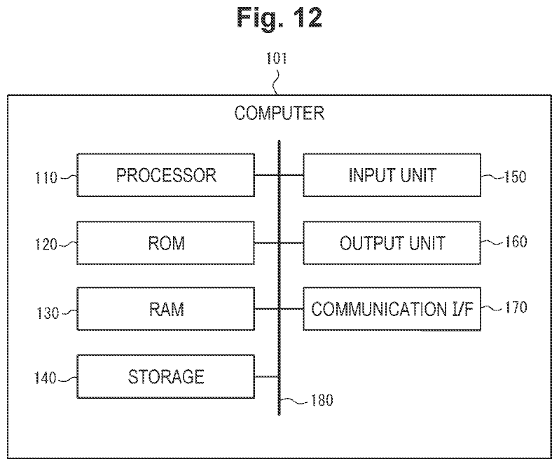

The region detection devices 3, 3-1, and 3-2 described above may be realized by a computer 101. A program for causing a computer to function as the region detection devices 3, 3-1, and 3-2 may be provided. The program may be stored in a storage medium or may be provided via a network. FIG. 12 is a block diagram illustrating a schematic configuration of the computer 101 that functions as each of the region detection devices 3, 3-1, and 3-2. Here, the computer 101 may be a general-purpose computer, a dedicated computer, a workstation, a personal computer (PC), an electronic notepad, or the like. A program instruction may be a program code, a code segment, or the like for executing required tasks.

As illustrated in FIG. 12, the computer 101 includes a processor 110, a read only memory (ROM) 120, a random access memory (RAM) 130, a storage 140, an input unit 150, an output unit 160, and a communication interface (I/F) 170. The respective constituents are communicatively connected to each other via a bus 180. Specifically, the processor 110 is a central processing unit (CPU), a micro processing unit (MPU), a graphics processing unit (GPU), a digital signal processor (DSP), a system on a chip (SoC), or the like, and may be formed with the same or different types of processors.

The processor 110 executes control on the respective constituents and various types of arithmetic processing. That is, the processor 110 reads a program from the ROM 120 or the storage 140 and executes the program by using the RAM 130 as a work region. The processor 110 controls the constituents described above and performs various types of arithmetic processing according to the program stored in the ROM 120 or the storage 140. In the embodiments described above, the program according to the present disclosure is stored in the ROM 120 or the storage 140.

The program may be stored in a storage medium that can be read by the computer 101. By using such a storage medium, it is possible to install the program in the computer 101. Here, the storage medium in which the program is stored may be a non-transitory storage medium. The non-transitory storage medium is not particularly limited, but may be, for example, a CD-ROM, a DVD-ROM, a Universal Serial Bus (USB) memory, or the like. The program may be downloaded from an external device via a network.

The ROM 120 stores various programs and various types of data. The RAM 130 temporarily stores a program or data as a working region. The storage 140 includes a hard disk drive (HDD) or a solid state drive (SSD), and stores various programs including an operating system and various types of data.

The input unit 150 includes one or more input interfaces that receive a user's input operation and acquire information based on the user's operation. For example, the input unit 150 is a pointing device, a keyboard, a mouse, or the like, but is not limited to these.

The output unit 160 includes one or more output interfaces that output information. Example of the output unit 160 include, but are not limited to, a display that outputs information as a video and a speaker that outputs information as a sound. The output unit 160 also functions as the input unit 150 in a case where the output unit is a touch panel display.

The communication interface (I/F) 170 is an interface for communicating with an external device.

Regarding the above embodiments, the following supplementary notes are further disclosed.

### Supplementary Note 1

A region detection device including:
a memory; and
at least one controller connected to the memory, in which
the controller
   detects a line segment from a captured image including an image of a target object having a linear band shape,
   extracts a main line segment that is the line segment having a length equal to or more than a predetermined value,
   generates, as a corrected image, a rotated image obtained by rotating the captured image such that the main line segment is perpendicular or parallel to an arrangement direction of pixels in the captured image, and
   detects a target object region indicating the image of the target object from the corrected image.

### Supplementary Node 2

The region detection device according to Supplementary Note 1, in which the controller generates, as the corrected image, an image obtained by reducing the rotated image such that an entire region of the captured image includes the entire rotated image.

### Supplementary Node 3

The region detection device according to Supplementary Note 1 or 2, in which
the controller
   detects edges from the captured image, and
   the line segment detection unit detects the line segment from the edges.

### Supplementary Node 4

The region detection device according to Supplementary Note 3, in which
the controller
   removes noise that is an edge less than a predetermined edge threshold value among the edges, and
   detects the line segment from an edge detected from the corrected image and not removed.

### Supplementary Node 5

The region detection device according to any one of Supplementary Notes 1 to 4, in which the controller extracts a main line segment that is the line segment having a maximum length.

### Supplementary Node 6

A region detection method including:
a step of detecting a line segment from a captured image including an image of a target object having a linear band shape;
a step of extracting a main line segment that is the line segment having a length equal to or more than a predetermined value;
a step of generating, as a corrected image, a rotated image obtained by rotating the captured image such that the main line segment is perpendicular or parallel to an arrangement direction of pixels in the captured image; and
a step of detecting a target object region indicating the image of the target object from the corrected image.

### Supplementary Node 7

A non-transitory storage medium storing a program that is executable by a computer, the program causing the computer to function as the region detection device according to any one of Supplementary Notes 1 to 5.

All documents, patent applications, and technical standards described in this specification are incorporated herein by reference to the same extent as if each individual document, patent application, and technical standard were specifically and individually described to be incorporated by reference.

Although the above embodiments have been described as representative examples, it is apparent to those skilled in the art that many modifications and substitutions can be made within the spirit and scope of the present disclosure. Accordingly, it should not be understood that the present invention is limited by the above embodiments, and various modifications or changes can be made within the scope of the claims. For example, a plurality of configuration blocks illustrated in the configuration diagrams of the embodiments may be combined into one, or one configuration block may be divided.

### REFERENCE SIGNS LIST

1 Image acquisition device
2 Image storage device
3, 3-1, 3-2 Region detection device
4 Data storage device
31 Input unit
32 Line segment detection unit
33 Main line segment extraction unit
34 Correction unit
35 Region detection unit
36 Output unit
37 Edge detection unit
38 Noise removal unit
100, 100-1, 100-2 Region detection system
101 Computer
110 Processor
120 ROM
130 RAM
140 Storage
150 Input unit
160 Output unit
170 Communication interface
180 Bus

1. A region detection system comprising:
detecting a line segment from a captured image including an image of a target object having a linear band shape;
extracting a main line segment that is the line segment having a length equal to or more than a predetermined value;
generating, as a corrected image, a rotated image obtained by rotating the captured image such that the main line segment is perpendicular or parallel to an arrangement direction of pixels in the captured image; and
detecting a target object region indicating the image of the target object from the corrected image.

2. The region detection system according to claim 1, wherein a corrected image is obtained by reducing the rotated image such that an entire region of the captured image includes the entire rotated image.

3. The region detection system according to claim 1, further comprising detecting edges from the captured image,
wherein the line segment from the edges is detected.

4. The region detection system according to claim 3, further comprising noise is removed to generate an edge less than a predetermined edge threshold value among the edges,
wherein the line segment is detected from an edge detected and the noise is not removed.

5. The region detection system according to claim 1, wherein a main line segment is extracted to generate the line segment having a maximum length.

6. A region detection method comprising:
detecting a line segment from a captured image including an image of a target object having a linear band shape;
extracting a main line segment that is the line segment having a length equal to or more than a predetermined value;
generating, as a corrected image, a rotated image obtained by rotating the captured image such that the main line segment is perpendicular or parallel to an arrangement direction of pixels in the captured image; and
detecting a target object region indicating the image of the target object from the corrected image.

7. (canceled)

8. A computer-readable non-transitory recording medium storing computer-executable program instructions that when executed by a processor cause a computer to execute a program generation method comprising:
detecting a line segment from a captured image including an image of a target object having a linear band shape;
extracting a main line segment that is the line segment having a length equal to or more than a predetermined value;
generating, as a corrected image, a rotated image obtained by rotating the captured image such that the main line segment is perpendicular or parallel to an arrangement direction of pixels in the captured image; and
detecting a target object region indicating the image of the target object from the corrected image.

9. The region detection system of claim 1, wherein output of the corrected image comprising object area indicated by predetermined color or pattern.
